(19) United States
(12) Patent Application Publication
(10) Pub. No.: US 2018/0039271 A1
(43) Pub. Date: Feb. 8, 2018

(54) FIXED-WING DRONE, IN PARTICULAR OF THE FLYING-WING TYPE, WITH ASSISTED MANUAL PILOTING AND AUTOMATIC PILOTING

(71) Applicant: PARROT DRONES, Paris (FR)

(72) Inventors: Ariel RIMOUX, Paris (FR); Frédéric PIRAT, Paris (FR)

(21) Appl. No.: 15/672,246

(22) Filed: Aug. 8, 2017

(30) Foreign Application Priority Data
Aug. 8, 2016 (FR) 1657623

(51) Int. Cl. G05D 1/00; G05D 1/08; G05D 1/04; B64C 39/02

(52) U.S. Cl. CPC G05D 1/0088; B64C 39/024; G05D 1/0808; G05D 1/042; G05D 1/0038; B64C 2201/028; B64C 2201/021; B64C 2201/141; B64C 2201/146; B64C 39/10

(57) ABSTRACT

A drone that includes an automatic piloting system that receives internal and/or external piloting instructions, as well as data of instantaneous attitude (φ*, θ*), altitude (z*) and speed (V*) delivered by sensors. Set point calculation circuits calculate, as a function of a model of the aerodynamic behaviour of the drone in flight, roll (φ) and/or pitch (θ) set points and/or speed set points (V) and/or altitude set points (z) corresponding to the internal and/or external piloting instructions received. Correction and control circuits control the propulsion system and the drone control surface servomechanisms. A system further allows generating internally piloting instructions for autonomous flight modes such as automatic take-off or automatic landing.

### CROSS REFERENCE TO RELATED APPLICATIONS

This application claims priority under 35 U.S.C. § 119(a) to French Patent Application Serial Number 1657623, filed Aug. 8, 2016, the entire teachings of which are incorporated herein by reference.

### BACKGROUND OF THE INVENTION

### Field of the Invention

The invention relates to remote-piloted flying motorized devices, hereinafter generally called “drones”, and more specifically, to fixed-wing drones

### Description of the Related Art

Fixed-wing drones of the “flying-wing” type include, for example, the EBEE(™) produced by SenseFly of Cheseaux-Lausanne, Switzerland, which is a professional land-mapping drone, or the DISCO(™) produced by Parrot S.A. of Paris, France. These drones are remotely piloted by a user provided with a remote-control device allowing him to send piloting instructions such as move up, move down, turn to the right or to the left, speed up/slow down, etc., and to visualize on a screen installed on the remote-control device the images captured by a camera of the drone. The drone, for its part, generates flight control commands as a function of the instructions received from the remote-control device: motor speed of the propulsion system, control surface commands, etc. These commands are feedback-controlled as a function of data provided by multiple sensors on board the drone, such as inertial unit (accelerometers and three-axis gyrometers), altitude sensors (barometer, ultrasonic range finder), air speed and/or ground speed measuring device, etc.

The fixed-wing drones, especially those of the “flying-wing” type, may fly at high speeds, typically up to 80 km/h, and are often rather difficult to pilot, taking into account their very high reactivity to the piloting instructions sent from the remote-control device, and the necessity to keep a minimal flight speed, higher than the stalling speed. Those constraints do not exist with the rotary-wing drones, for example of the quadricopter type, that may keep a fixed point and fly as slowly as wanted, which makes them far easier to pilot, even by inexperienced users.

A fixed-wing drone includes a propulsion system with one or several propellers driven by a motor, and control surfaces controlled by respective servomechanisms. The drone flight evolutions are controlled by varying the speed of the motor(s) (controlled variation of the power-supply current) and by acting on the control surfaces in order to control the trajectory of the drone.

With his remote-control device provided with proportional commands of the joystick type, the user varies the motor speed to increase or decrease the propulsive force, and acts on the different control surfaces of the drone to modify the attitude of the latter.

Piloting such a drone requires a certain skill, that the users who evolve in the scale model aircraft universe know how to acquire. On the other hand, for the novice or simply occasional users, piloting a fixed-wing drone is not intuitive, and the risks of error are important, with for consequence risks of fall, loss of control of the drone, etc.

Those difficulties are particularly critically increased in the case of drones of the flying-wing types. Indeed, these drones are devoid of empennage and rudder unit, and have hence no mobile direction control vertical surface (such as a flap placed on the rudder, in the case of a conventional aircraft). The flying-wing is provided, as control surfaces, with only two mobile flaps arranged on the trailing edges of the wings: displacements of these flaps in the same direction modify the pitch attitude (angle θ) of drone, whereas displacements in opposite direction of these two flaps modify the roll attitude (angle φ) of the drone, and the latter has no other aerodynamic means for controlling its trajectory, except the motor speed control.

To make the drone fly, the user must hence control from his remote-control device the position of the two flaps to modify the pitch and roll attitude of the drone, a modification that it possibly accompanied with an increase or a decrease of the speed.

Such a piloting mode is anything but easy and intuitive, and the difficulty is further increased by the very unstable character of a flying-wing, in particular in turn, with respect to an aircraft provided with a rudder, and that is why the aircrafts of this type are not very widespread.

To compensate for this difficulty, it has been proposed, as described in A Bittar et al., “Central Processing Unit for an Autopilot: Description and Hardware-in-the-Loop Simulation”, Journal of Intelligent and Robotic Systems, Vol. 70, No 1-4, Aug. 4, 2012, pp. 557-574, to preserve the pleasure of the manual piloting by the user, by offering him an assisted piloting mode in which he just needs to manage simplified commands (hereinafter “instructions”) of the “turn to the right” or “ turn to the left”, “move up” or “move down”, “speed up” or “slow down” type, such instructions being generated for example by means of joysticks of the radio-control apparatus.

The auto-piloting on-board software translates these very simple instructions into aircraft attitude set points, i.e. into roll angle set points and pitch angle set points, as well as into speed set points. The set points so produced by the autopilot are compared, within suitable control loops, with the data produced by on-board sensor that evaluate at any time the real instantaneous attitude of the aircraft, the altitude thereof, the air and/or ground speed thereof, etc., to produce suitable commands for the control-surface steering servomechanisms for controlling the attitude, or commands for the propulsion system for controlling the speed.

However, even with these simplified commands, the user must in any case ensure the piloting in an uninterrupted manner and whatever the circumstances.

There is for example no possibility for him to release the commands of his remote-control device, by no longer touching the joysticks nor pressing any button, etc.

With a rotary-wing drone such as a quadricopter, such a manoeuver would immediately cause the switching to a hovering flight configuration in which the drone is maintained in flight, at a fixed point, at the altitude at which it was when the commands had been released.

On the other hand, in the case of a fixed-wing drone, this way to proceed is not possible because the drone cannot be immobilized, at the risk of stalling.

### BRIEF SUMMARY OF THE INVENTION

One of the objects of the present invention is to allow the user to free from this limitation, by offering him the possibility to quit the manual piloting mode (assisted by the autopilot) for a fully-automated piloting mode, triggered for example by an intuitive command consisting in simply releasing the commands of the remote-control device.

According to another aspect of the problem, it will be underlined the very delicate character of the take-off and landing phases of a fixed-wing drone, which require a lot of experience.

Indeed, in the case of a rotary-wing drone, for example a quadricopter, the take-off is carried out with the drone on the ground; the power up and the progressive increase of speed of the motors allow the drone to slowly lift up, generally up to a fixed-point position at a predetermined distance above the ground, from which it will be able to begin flying along a chosen and controlled trajectory. Conversely, for the landing, the drone begins by staying at a fixed point then slowly moves down towards the ground, by progressive decrease of the motor speed.

On the other hand, in the case of a fixed-wing drone, such a procedure is not possible, taking into account the constraint of a minimum lift speed. For the take-off, the drone must be held in hand by the user, then thrown head to the wind with the motor operating at a sufficient speed to prevent the stalling. And for the landing, the speed of the drone must be reduced progressively to make it move down gently sloping from its cruse altitude to the ground level at the slowest possible speed, so that the stalling occurs only at the immediate proximity of the ground level so as not to damage the drone at the landing.

As easily conceived, these extremely critical phases require a particular skill of the user, and hence a lot of experience in piloting such aircrafts.

It is the same if the user searches to make the aircraft fly along a predetermined trajectory, such a stable circular orbit (“loiter” in aeronautical terminology), a spiral trajectory, etc. These trajectories require simultaneous actions on several commands, not only to follow the desired trajectory, but also to compensate for the various disturbances that the aircraft may undergo, especially the lateral wind effect.

Hence, to solve this problem and generally to facilitate as much as possible the piloting of a fixed-wing drone, another object of the invention is to offer to the user a certain number of autonomous drone flight modes, managed by an automatic system.

The matter is in particular to manage fully automatically and in the better conditions the critical phases of drone take-off and/or landing, without needing the user to intervene—by potentially reserving an option so as to offer him a possibility of “over-piloting”, i.e. superimposition of manual instructions onto the instructions generated internally by the on-board auto-pilot.

To reach these objectives, the invention proposes a fixed-wing drone of a type disclosed in the above-mentioned article of A Bittar et al., including a propulsion system, control surfaces and an automatic pilot.

### More Precisely, the Automatic Pilot is Configured To:

calculate set points as a function of instructions, the instructions including internal piloting instructions generated by the automatic pilot and external instructions received by the drone, the internal and/or external instructions including turn instructions, move up/move down instructions and speed change instructions, and the set points including a roll angle set point, a pitch angle set point and a speed set point for the implementation of the internal and/or external instructions; and
control the propulsion system and the control surfaces as a function of the calculated set points.

The automatic pilot is further configured to, upon application of a turn instruction and/or a speed change instruction, calculate the roll angle set point, the pitch angle set point and the speed set point so as to perform a turn and/or a speed change while maintaining constant an altitude of the drone during the turn and/or the speed change.

Characteristically of the invention, the automatic pilot is further configured to, upon cessation of receipt of at least certain of the external piloting instructions, generate the roll angle set point, the pitch angle set point and the speed set point so as to maintain constant the heading and the altitude the drone had at the time of the cessation of receipt of at least certain of the external piloting instructions.

Preferably, the automatic pilot is configured to, upon cessation of receipt of any external piloting instruction, generate the roll angle set point, the pitch angle set point and the speed set point so as to further maintain constant the speed the drone had at the time of the cessation of receipt of any external piloting instruction.

In an advantageous particular embodiment, the at least certain external piloting instructions include the turn external piloting instructions and the move up/move down external piloting instructions, and do not include the speed external piloting instructions.

In this case, the automatic pilot may further be configured to, upon receipt of speed external piloting instructions and with no receipt of turn external piloting instructions nor receipt of move up/move down external piloting instructions, continue generating the roll angle set point and the pitch angle set point so as to maintain constant the heading and the altitude the drone had at the time of the cessation of receipt of turn external piloting instructions and move up/move down external piloting instructions, and generate the speed set point based on the move up/move down external piloting instructions received.

In this same case, the automatic pilot may also be configured to, upon receipt of turn external piloting instructions or move up/move down external piloting instructions, stop generating the roll angle set point, the pitch angle set point and the speed set point that had been generated so as to maintain constant the heading and the altitude the drone had at the time of the cessation of receipt of turn external piloting instructions and move up/move down external piloting instructions.

According to various advantageous subsidiary characteristics of the present invention:
in an autonomous operating mode, the automatic pilot is configured to generate internal piloting instructions including turn instructions, move up/move down instructions and/or speed instructions;
the automatic pilot is configured to generate internal piloting instructions according to an automatic take-off mode with a phase of moving up to a predetermined altitude followed with a phase of waiting in orbital flight at the predetermined altitude;
this automatic take-off mode includes successively: a phase of operating the propulsion unit of the propulsion system at slow speed, a phase of operating the propulsion unit at a faster speed, a phase of moving up in straight line with holding of the heading, and the phase of waiting in orbital flight when the predetermined altitude is reached;
the automatic pilot is configured to generate internal piloting instructions according to an automatic landing mode, with potential superimposition, onto the piloting instructions generated by the automatic pilot, of external piloting instructions received by the drone;
this automatic landing mode includes successively: a phase of moving down to a predetermined altitude, a phase of moving down along a helical trajectory or according to a linear trajectory, and a phase of inversion of the direction of rotation of the propulsion unit of the propulsion system;
the automatic pilot is configured to calculate the set points as a function of a difference between the air speed of the drone and the ground speed of the drone;
the automatic pilot is configured to calculate the set points so as to fly at constant air speed or at constant ground speed in a constant-speed operating mode;
for the execution of a turn instruction, the automatic pilot is configured to calculate the set points so as to perform the turn with a constant turn rate with respect to the ground.

The present invention also relates to a method of piloting a drone, this method including the above-described steps implemented by the automatic pilot of the drone.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a general view showing a fixed-wing drone of the flying-wing type, flying in the air under the control of a distant remote-control device.

FIG. 2 is a very simplified diagram of the different functional blocks of the drone and of the remote-control device.

FIG. 3 is a block diagram of an automatic pilot integrated in the drone for the implementation of the present invention.

FIG. 4 illustrates an example of ergonomic distribution of commands at the disposal of the user on his remote-control device.

FIG. 5 is a step diagram illustrating in particular the possibility of transition between assisted manual piloting mode and autonomous flight piloting mode.

FIG. 6 illustrates the autonomous flight mode of putting into orbit and automatic return to the starting point.

FIG. 7 illustrates the drone throwing operation at the take-off.

FIG. 8 is a step diagram illustrating the autonomous flight mode of take-off of the drone.

FIGS. 9a and 9b illustrate the drone landing operation, respectively circular and linear.

FIG. 10 is a step diagram illustrating the autonomous flight mode of landing of the drone.

### DETAILED DESCRIPTION OF THE INVENTION

An exemplary embodiment of the device of the invention will now be described.

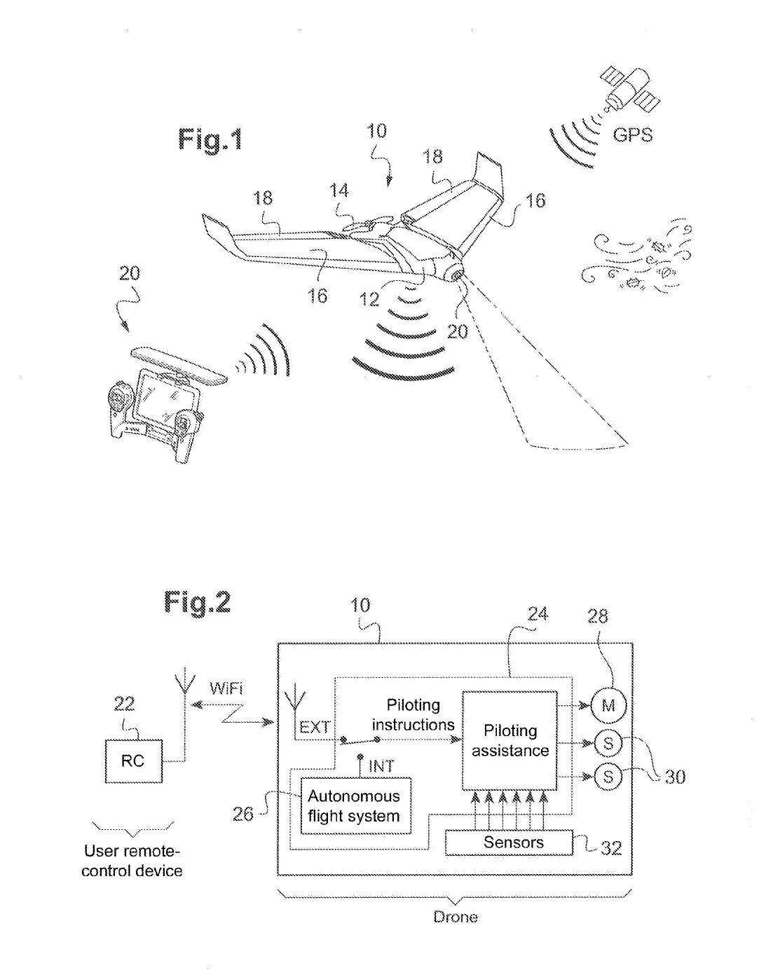

In FIG. 1 is illustrated a drone 10, herein a fixed-wing drone of the flying-wing type. This drone 10 includes a drone body (fuselage) 12 provided, in the rear part, with a propulsion system consisted for example of a motor and a propeller 14 and, laterally, with two wings 16, these wings continuing the drone body 12 in the illustrated configuration of the “flying-wing” type. On the trailing edge side, the wings 16 are provided with control surfaces 18, which are steerable by means of servomechanisms to control the trajectory of the drone. The drone is also provided with a front camera 20 allowing obtaining an image of the scene towards which the drone flies.

The drone 10 is piloted by a distant remote-control device 22 provided with a touch-screen configured to display the image captured by the camera 20, as well as various piloting commands at the disposal of the user. The remote-control device 22 is a touch-screen multimedia digital tablet. The remote-control device 22 is also provided with means for radio link with the drone, for example of the Wi-Fi (IEEE 802.11) local network type, for the bidirectional exchange of data: from the drone 10 to the remote-control device 22, in particular for the transmission of the image captured by the camera 20, and from the remote-control device 22 to the drone 10 for the sending of piloting instructions to the latter. The user may also use immersive piloting glasses, called FPV (“First Person View”) glasses.

FIG. 2 is a very simplified functional diagram of the unit consisted by the drone 10 and the remote-control device 22. The drone 10 includes an automatic pilot 24 configured to implement an assistance to the piloting of the drone 10. The automatic pilot includes a number of modules. The automatic pilot 24 receives as an input piloting instructions coming from the remote-control device 22 (“external piloting instructions”), i.e. instructions sent by the user from the remote-control device 22 in assisted piloting mode, instructions which are transmitted by radio link between the remote-control device 22 and the drone 10.

The automatic pilot is further configured to automatically generate piloting instructions (“internal piloting instructions”). The automatic pilot includes for that purpose an autonomous flight module 26. The automatic pilot is configured to generate internal piloting instructions, for example in automatic take-off mode, automatic landing mode, etc. It will be noted that, in a particular “over-piloting” mode, the use has the possibility to superimpose his own instructions onto those automatically generated by the autonomous flight module 26, for example to intervene on a trajectory imparted by this system in order to correct this trajectory at the user's will.

The propulsion system of the drone 10 includes a propulsion unit including the propeller 14 and a motor 28 for the driving into rotation of the propeller 14. The drone 10 includes servomotors 30 to control the position of the control surfaces 18.

Based on the so-received piloting instructions, the automatic pilot 24 generates commands for the motor 28, and the servomotors 30 controlling the control surfaces 18.

In the illustrated example of a drone of the “flying-wing” type, the motor 28 is unique and the servomotors 30 are only two in number (a respective servomotor for each of the two control surfaces 18). It is however only an illustrative example, as a drone can be provided with several propulsion units, hence with several corresponding motors, and with additional control surfaces, for example in the case of a fixed-wing drone provided with an empennage and a rudder unit on the rear part, which would hence not be of the flying-wing type.

The drone is also provided with a set 32 of sensors delivering dynamically to the automatic pilot 24 information about the real instantaneous attitude, altitude and speed of the drone.

### The Set of Sensors 32 Includes for Example:

an inertial unit (IMU) including accelerometers and three-axis gyrometers;
a sensor for measuring the air speed of the drone, connected to a dynamic pressure intake of an element of the “Pitot tube” type;
a GPS module giving the absolute position of the drone in a geographical reference system;
a barometric sensor allowing determining the variations of altitude of the drone (instantaneous variations and variations with respect to a known starting altitude);
a magnetometric sensor giving the direction of the drone with respect to the geographical North;
an ultrasonic range finder sensor giving the altitude of the drone with respect to the overflown terrain; and
a vertical-view camera giving an image of the overflown terrain and allowing determining, by an image processing, the speed of the drone with respect to this terrain (ground speed, by opposition to air speed given by the Pitot tube).

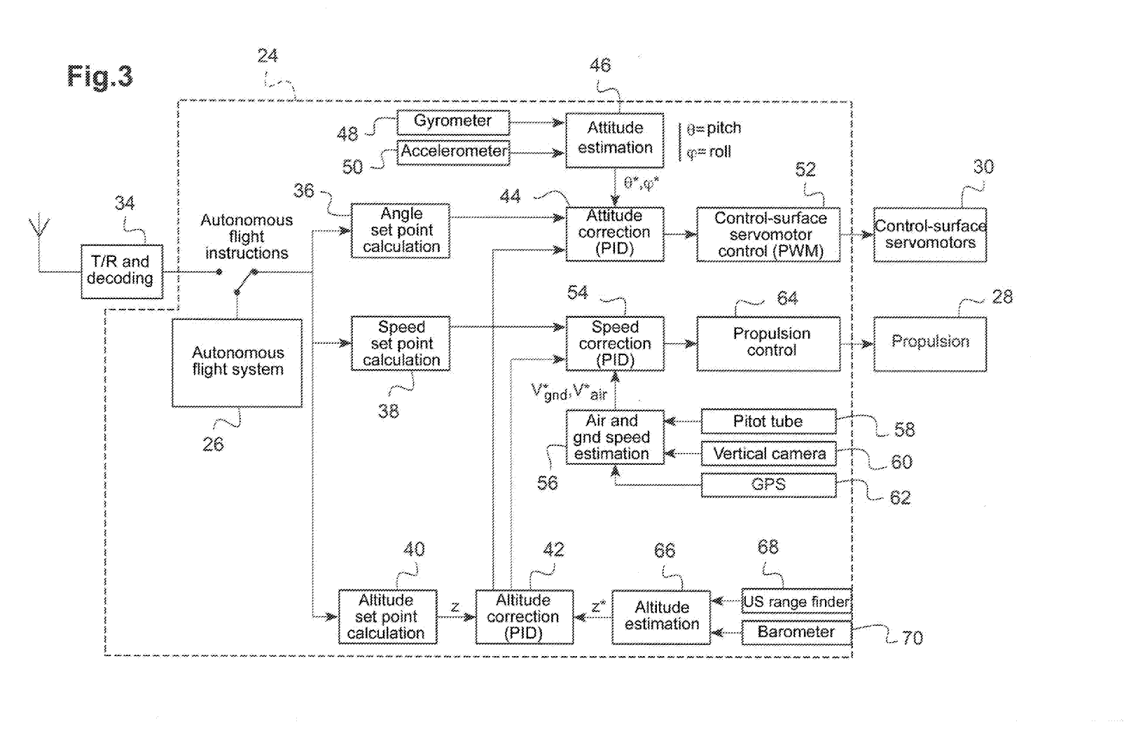

The different elements for assisted piloting and autonomous flight piloting of the drone according to the invention will now be described, with reference to the block diagram of FIG. 3.

The piloting instructions coming from the user remote-control device in assisted piloting mode (“external instructions”) are received and decoded by a decoder module 34, which delivers instructions of the “turn to the right” or “turn to the left”, “move up” or “move down”, “seep up” or “slow down” type. These instructions are for example proportional instructions generated by means of manipulators or commands such as joysticks of the remote-control device 22 as a function of the evolution the user desires to impart to the trajectory of the drone.

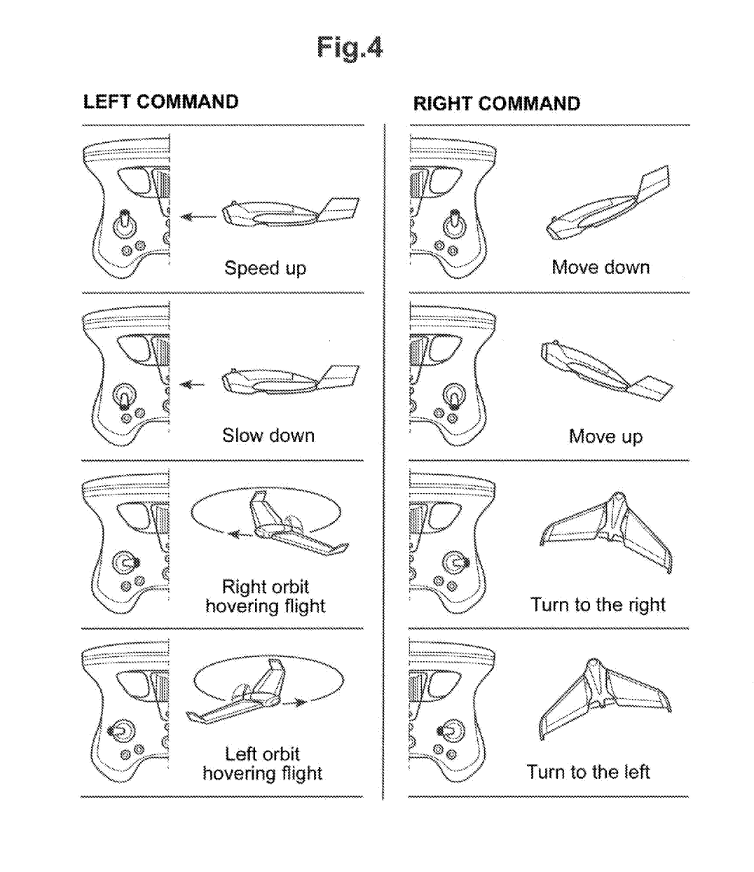

FIG. 4 illustrates an example of ergonomic distribution of the commands at the disposal of the user on the remote-control device 22:
with the joystick located on the left:
joystick actuated upward or downward: speed up/slow down
joystick actuated to the right or to the left: right or left orbit hovering flight (loiter),
with the joystick located on the right:
joystick actuated upward or downward: move up/move down
joystick actuated to the right or to the left: turn to the left/turn to the right.

In autonomous flight mode, the autonomous flight module 26 of the automatic pilot 24 generates itself instructions (“internal instructions”) corresponding to an imparted trajectory, such as for example automatic take-off, automatic landing, orbit about a predetermined point, etc. Moreover, it will be noted that, in a particular “over-piloting” mode, the use has the possibility to superimpose his own instructions (external) onto those automatically generated (internal) by the autonomous flight module 26, for example to intervene on a trajectory imparted by the autonomous flight module 26 in order to correct this trajectory.

### Operation of the Autopilot

The external and/or internal piloting instructions are applied to a module 36 for calculating drone attitude angle set points (pitch angle set point θ and roll angle set point φ), to a module 38 for calculating drone speed set points (speed set point V), and a module 40 for calculating drone altitude set points (altitude set point z).

Based on i) the external and/or internal piloting instructions as defined hereinabove and ii) a model of the aerodynamic behaviour of the drone in flight, previously determined and kept in memory, each of the modules 36, 38, 40 determines corresponding pitch angle θ and roll angle φ, speed V and altitude z set points, respectively.

For an internal or external turn instruction, the module 36 for calculating angle set points determines at least one angle set point such as the roll φ, a pitch set point θ being produced by an altitude correction module 42, which will be described in detail hereinafter. Indeed, a turn instruction requires acting on the motor and on the control surfaces because, when it turns the drone losses speed. If no speed or altitude change instruction is given by the user with the turn instruction, to compensate for the loss of altitude, the altitude correction module 42 determines pitch and speed set points, calculated based on the last instruction before the turn instruction, to maintain the drone at constant speed and altitude during the turn.

The pitch angle θ and roll angle φ set points produced by the module 36 and the module 42 are applied to an attitude correction module 44 of the PID regulator type. This module 44 corrects the set points delivered by the modules 36 and 42 as a function the effective instantaneous attitude of the drone (pitch angle θ* and roll angle φ*), determined by an attitude estimation module 46, based on gyrometric and accelerometric data provided by the sensors 48 and 50 of the inertial unit of the drone.

The resulting corrected set points produced at the exit of the module 44 are transmitted to a power module 52 for controlling the control surface servomotors. This module generates controlled PWM signals, applied to different servomotors 30 for driving the control surfaces.

For an internal or external speed increase/decrease instruction, the module 38 for calculating speed set points determines a speed set point V. A second speed set point V is determined by the above-mentioned altitude correction module 42 (module that also determines the pitch set point θ).

The speed set points V produced by the module 38 and by the module 42 are applied to a speed correction module 54 of the PID regulator type (the two speed set points being combined, with priority of correction given to the altitude holding). This module 54 corrects the speed set point V delivered by the modules 38 and 42 and as a function of the effective instantaneous ground speed V*_{ground} and air speed V*ₐᵢᵣ of the drone based on the data delivered by the Pitot tube 58 (for the air speed) and by the analysis of the image of the vertical camera 60, as well as by the data of the GPS module 62 (for the ground speed).

The resulting corrected speed set points produced at the exit of the module 54 are transmitted to a power module 64 for controlling the propulsion unit 28. This module 64 generates a controlled current allowing varying as desired the speed of the propulsion unit 28, and hence the thrust of the propeller 14.

The internal or external, move up/move down and/or turn instructions are applied to the altitude set point calculation module 40, that delivers an altitude set point z of the drone. This set point z is applied to the altitude correction module 42, which is for example a module of the PID regulator type. This module 42 corrects the altitude set point z as a function of the effective instantaneous altitude z* of the drone, determined by an altitude estimation module 66 based on the data provided by the GPS module 62, by the ultrasonic range finder 68 and by the barometric sensor 70. Here again, when a speed instruction is given, the altitude correction module 42 and attitude correction module 44 calculate the set points so as to give the priority to the holding of the altitude and the heading of the drone.

The corrected set points resulting from the altitude correction delivered by the module 42 include a pitch set point θ and a speed set point V, because the increase of the drone altitude is produced by increasing the motor speed and by nosing up the drone, and the reverse for a decrease of the altitude (wherein a loss of altitude can also, as explained hereinabove, result from a turn instruction, this loss of altitude having to be compensated for).

In a particular embodiment, the modules of the automatic pilot 24 are software-implemented. The modules are provided as software applications recorded in a memory of the drone 10 and executed by a processor of the drone 10. As a variant, at least one of the modules is a specific electronic circuit or a programmable logic circuit.

The way the piloting of a flying-wing is operated, manually or automatically, thanks to the just-described circuits will now be described.

Assisted manual piloting

In manual (or assisted piloting) mode, the piloting assistance ensures in particular the automatic management of the roll, the pitch and the speed of the drone.

In a conventional piloting configuration of a flying-wing, the user tries to adjust at best the roll and the pitch by a separated operation of the two control surfaces of the drone. If the user imparts to the wing a roll inclination, the wing will tilt to one side and will begin to turn to the side to which it tilts. But, due to the fact that it is no longer flat, the wing loses lift, and hence altitude. The user must hence, to compensate for this loss of altitude, increase the pitch command, so as to slightly nose up the drone and hence increase the positive lift and/or the speed of the drone. Hence, with a conventional piloting, for a simple turn, it is necessary to act at once on the roll, the pitch and the speed of the drone.

With an assisted piloting, the roll, pitch and speed adjustment is operated transparently for the user, who only addresses a “turn to the left” or “turn to the right” instruction, the wing turning automatically in the prescribed direction and with no loss of altitude.

According to another aspect, the user may send speed-up or slow-down instructions, i.e. instructions for decreasing or increasing the speed. Thanks to the assisted piloting, in all the possible choices of speed, the wing automatically maintains its altitude, without the user has to give pitch modification instructions (to avoid that the wing gains in altitude when the speed increases) if he only wants to accelerate the drone, at constant altitude.

By default, the speed of the drone that is managed by the assisted piloting it that which favours the maximum autonomy. If, upon receipt of a user instruction, whatever it is (turn, move up/move down), the speed of the drone is too low for the required action to be executed without stalling, the assisted piloting automatically increases the speed of rotation to increase the thrust, and thus the speed, and hence allow the execution of the instruction addressed by the user.

As regards the management of the altitude, the latter is, as described hereinabove, controlled by the PID regulator of the module 42, as a function of the difference between the altitude set point z that the drone is desired to maintain, the effective instantaneous altitude z* estimated based on the sensor measurements. An additional speed compensation may be produced when this difference is higher than a predetermined value, for example when the real altitude of the drone is at more than 3 metres under the altitude set point. On the other hand, a physical limitation may be activated to limit the altitude of the drone between minimum and maximum values.

Another advantageous aspect of the assisted piloting is that of the compensation for the effects of the lateral wind (the direction and the intensity of the lateral wind may be estimated by calculating the difference between the air speed and the ground speed, for different values of yaw angle).

The assisted piloting has data produced by the GPS module, in particular the heading direction followed by the drone, which allows keeping a rectilinear trajectory. In the presence of a mean wind or gusts, the assisted piloting automatically compensates for the thrust exerted by the wind on the drone and maintain a straight-line flight direction. For the drone to go in a straight direction, a landmark or waypoint (see hereinafter) is calculated based on the estimated position of the drone and the direction of displacement thereof, and the assisted piloting feedback controls the trajectory of the drone so that the latter follows the line going to this waypoint.

In the case of head wind, which may even prevent the drone from moving forward (the ground speed being then negative), the assisted pilot may compensate for the wind by analysis of the ground speed and by correction of the speed set point so as to guarantee a minimum ground speed, for example of 5 m/s, so that the drone can always move forward relative to the ground.

As regards the “turn to the right” or “turn to the left” instructions, they are very advantageously instructions for a turn with a constant turning rate.

A constant rate turn consists in making the drone follow a circular trajectory, with a predetermined linear speed and a constant altitude. The user will then have only one degree of freedom to control (the “turning rate”), essentially linked to the more or less great radius of the circular trajectory (the turn being all the more tight that the radius of curvature is small), which makes the control of the drone in turn very easy and intuitive. It hence becomes possible to very easily negotiate turns, to link them together at high rhythm, etc., far more easily than with a traditional piloting in which the user must combine and control roll and pitch commands. With the assisted piloting system of the invention, the user just needs to give a simple turn rate set point (more or less tight turn), possibly completed by a speed up or slow down instruction.

Of course, the assisted piloting acts in such a manner that, whatever the instructions produced by the user, the set points calculated as a function of these instructions remain always in the aerodynamically acceptable limits of flight of the drone, in particular:
maximum speed of the drone,
minimum speed of the drone (stalling speed),
maximum turn rate (mainly function of the air speed), and
maximum move up/move down rate.

Assisted manual piloting/autonomous flight piloting transition

An advantageous functionally, characteristic of the invention, is the possibility to quit the assisted manual piloting mode for a fully automatic piloting mode by an intuitive command where the user simply releases the commands of his remote-control device, for example he does no longer touch the joysticks, press any button, touch the touch screen, etc.

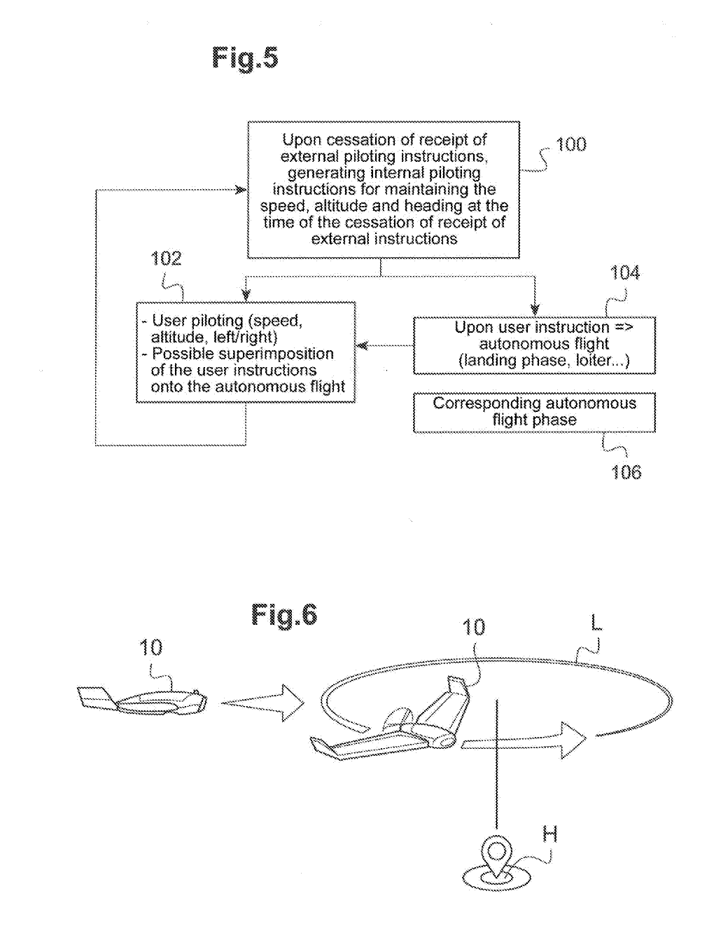

This aspect of the invention is in particular illustrated by the step diagram of FIG. 5.

The cessation of receipt of external piloting instructions by the user (block 100 in FIG. 5) triggers the automatic piloting of the drone along a trajectory of constant altitude and of constant air speed, in the same direction (heading angle) than that it had when the user released the commands (i.e. the turn or move up/move down commands, because, if the user acts only on the speed, the drone will keep its altitude and heading, as indicated hereinabove). The autonomous flight module then keeps the heading of this trajectory, by compensating if need be for the lateral wind.

The user may at any time take the hand back (block 102), for example by operating a joystick, by pressing a button, by touching the touch screen, etc., or address to the drone a command of switching to the autonomous flight, for example of landing or putting onto orbit (block 104).

This action will generate an external piloting instructions, received and detected by the drone, which will then switch back to the assisted manual piloting mode (block 102), or to the autonomous flight (block 106), according to the case.

In a variant embodiment, the giving up of the automatic piloting mode occurs in the above conditions, except the receipt of an external speed command, that does not trigger a return to the assisted manual piloting mode or to an autonomous flight mode.

The matter is to hence provide the user with the possibility to speed up or slow down the drone, whereas the latter continues its trajectory under the control of the automatic pilot, with the advantages offered by the automatic piloting, in particular the compensation for the external disturbances such as those resulting from a lateral wind.

### Specific Autonomous Flight Modes

The on-board autonomous flight module may control the behaviour of the drone so as to make it follow particular pre-programmed trajectories.

Hence, upon a “putting into orbit” instruction received by the user, the autonomous flight module takes the hand and generates instructions allowing the drone to indefinitely go round in circles, along flat circles for example of 30 m of radius and with no loss of altitude, this flight mode being called “loiter” in the aeronautic technique.

FIG. 6 illustrates this autonomous flight mode of putting the drone 10 into orbit over a circular orbit L.

As soon as the user touches the joystick or any other command, he takes the hand back, the drone passing to an assisted manual piloting mode.

In a safety function, the user may at any time address an instruction to the drone to ask it to come back to its take-off point, the coordinates of this point being known by the GPS module data that have been saved in memory. The autonomous flight module then takes the hand and executes the necessary actions.

Advantageously, if, at the time of the switching to the automatic mode, the drone is at an altitude lower than 50 m, for example, the automatic pilot makes it move up back to 50 m, to engage the trajectory of return to the take-off point. If at the time of the switching to the automatic mode, the drone is at an altitude higher than 50 m, it remains at its current altitude to begin the phase of return to the take-off point.

A variant consists in memorizing the maximum altitude taken by the drone in the flight phase preceding the sending of the instruction of return to the take-off point, and in making the drone move up back to this maximum altitude value before beginning the automatic return to the take-off point. This allows for example avoiding a hill that would have been overflown during the outward trip.

Comparably, when the link between the drone and the remote-control device is lost, whatever the reason, a procedure of automatic return to the take-off point is automatically initiated. The drone verifies the possible restoring of the connection during this return phase, and if no connection has been restored, the drone follows, as illustrated in FIG. 6, an orbit L around the take-off point H, then lands after a predetermined time, parameterizable, if the radio link is not yet restored, which allows not to lose the drone if the battery of the remote-control device is discharged.

Another possibility offered by the autonomous flight module is to manage automatically the trajectory of the drone according to a pre-established flight plan. The flight plan is previously determined by a series of “control points” or waypoints and the autonomous flight module maintains the drone in flight and directs it towards these waypoints: the drone goes towards the current waypoint of the flight plan according to a rectilinear trajectory, then, when the waypoint is reached, it turns around the latter following a circular trajectory, for example with a radius of 30 m. To follow at best the circle, the autonomous flight module calculates suitable altitude and roll set points. The drone then determines the direction between the current waypoint and the next waypoint, and feedback controls the trajectory thereof along a new heading, the heading feedback control being determined as a function of the distance between the estimated position of the drone (given by the GPS) and the line separating the two waypoints.

Finally, the autonomous flight module allows, for safety reason, implementing a “flight cylinder”, defined as being a zone in which the drone will be allowed to fly, whose centre is the take-off point of the drone, and that is limited in distance and altitude (minimum altitude and maximum altitude).

If the drone goes beyond the maximum distance allowed, the autonomous flight module takes the hand back and bring the drone back towards the user. As long as the drone has not come back in the flight cylinder, the manual piloting, even assisted, is not allowed. If the drone exceeds the maximum altitude allowed, the autonomous flight module automatically bring it back under the maximum altitude, and the external move-up instructions that the user could send won't be taken into account as long as the drone will be above this maximum altitude. Likewise, the drone won't be able to fly under a minimum altitude, to avoid any risk of accident by a flight too close to the ground.

### Automatic Take-Off

The autonomous flight module allows managing fully automatically the take-off of the drone.

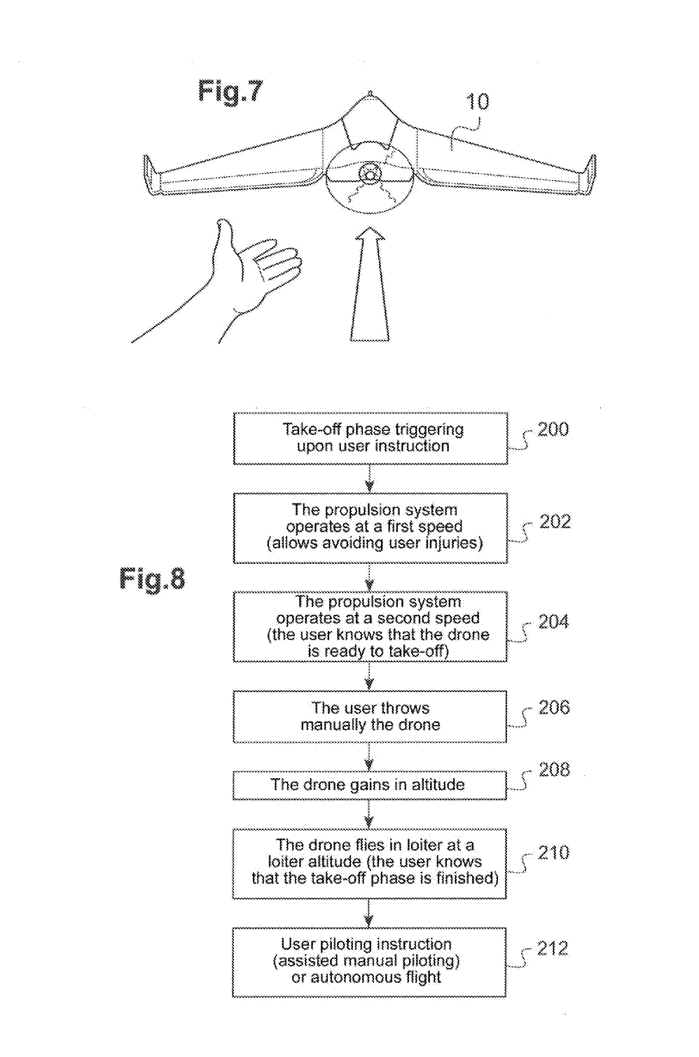

This aspect of the invention is illustrated in particular in FIG. 7 and by the step diagram of FIG. 8.

The user operates a suitable button of the remote-control device (block 200 of FIG. 8), which has for effect to operate the motor at a first speed, slow and with no danger for the user (block 202), then at a second speed, faster, that indicates to the user that the drone is ready to take-off (block 204). The user then throws the drone head to the wind (block 206, and illustration of FIG. 7), and the drone, controlled by the autonomous flight module, moves up along a straight line (block 208) for example with an incidence of 30° up to an altitude of 50 m, while maintaining its heading (i.e. that, even in the presence of lateral wind, the drone does not vary from this trajectory). Through joysticks, the user may possibly “over-pilot” the drone if he desires to change the heading.

Once the altitude reached (50 m in the above example), the drone goes fully autonomously into orbit (see hereinabove), for example with circles of 30 m of radius (block 210). The user has hence the guarantee that, while waiting for taking the commands, the drone remains close to the place where it is. During this orbit phase, the drone may advantageously collect data from the sensors to measure the direction and intensity of the lateral wind.

As soon as the user touches the joysticks of the remote-control device or any other command, he then takes the hand back (block 212), and the flight then becomes an assisted piloting flight, or an autonomous flight mode ordered by the user, with the above-described characteristics.

### Automatic Landing

The automatic landing is another mode managed by the autonomous flight module.

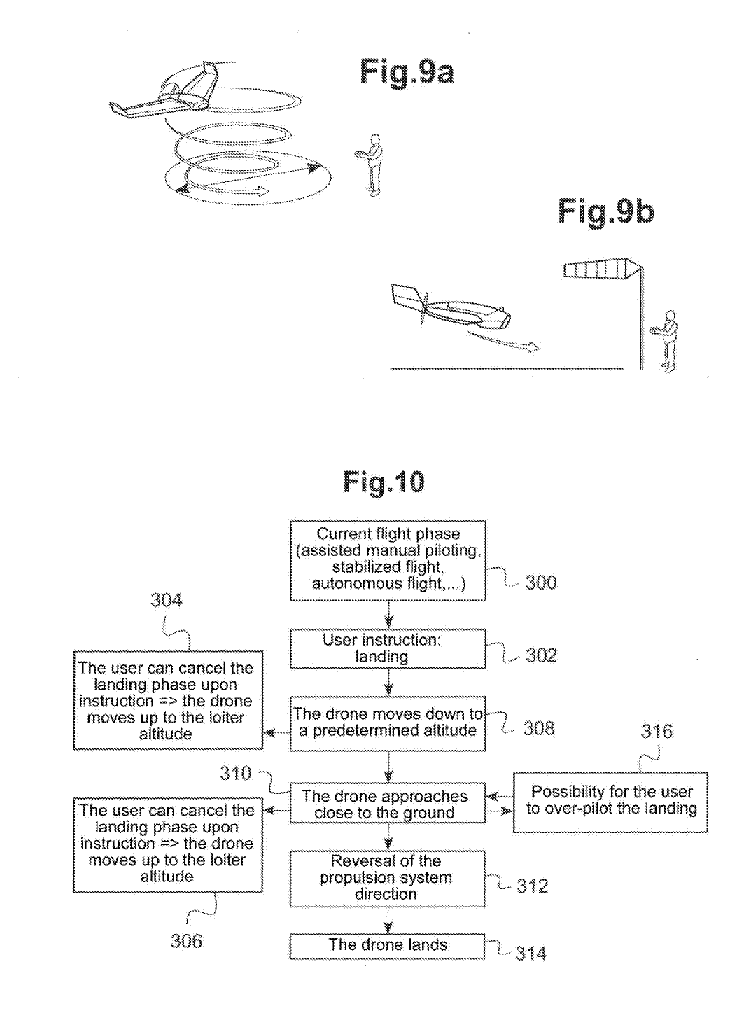

This aspect of the invention is in particular illustrated by FIGS. 9a and 9b and by the step diagram of FIG. 10.

The user has on his remote-control device a suitable landing instruction key, which, from the current flight phase, whether it is in manual mode or in autonomous mode (block 300), triggers (block 302) the execution of the corresponding procedure that will be described hereinafter. If he presses again on this same key (blocks 304, 306), the current landing procedure is abandoned.

The automatic landing may be operated in circular mode (the drone landing by moving down along a helical trajectory of predetermined radius, for example a radius of 30 m), or in linear mode (the drone landing in straight line).

In the case of a circular landing, as illustrated in FIG. 9a, the drone performs at least one complete circle by moving down for example to an altitude of 25 m (block 308), which allows measuring the direction and the force of the lateral wind. In a second time, once this wind measurement taken, it initiates the final moving down (block 310) according to a helical trajectory, by calculating the ideal trajectory allowing it to arrive at the ground level, head to the wind. During the descent, when the drone reaches predetermined altitude and speed, the direction of rotation of the propulsion unit is reversed (block 312), which allows the drone to brake and to arrive on the ground (block 314) with a low speed allowing minimizing the impact of the landing shock. It will be noted that, as indicated hereinabove, the user may at any time cancel the landing procedure (blocks 304, 306), the system then automatically switching to the automatic take-off mode to allow the drone to regain altitude and speed.

In the case of a linear landing, as illustrated in FIG. 9b, the final landing phase is initiated when the drone is at low altitude, for example an altitude of the order of 3 to 5 m. The drone brakes with rotation of the motor in the reverse direction, to touch the ground at low speed.

It is also possible, in a procedure of “assisted landing”, to allow an action of the user so that the drone moves down in straight line by maintaining its heading, the user operating an “over-piloting” during the landing (block 316) to control the roll angle as well as the pitch angle.

Having thus described the invention of the present application in detail and by reference to embodiments thereof, it will be apparent that modifications and variations are possible without departing from the scope of the invention defined in the appended claims as follows:

What is claimed is:

1. A fixed-wing drone, comprising:
a propulsion system, control surfaces and an automatic pilot, wherein the automatic pilot is configured to:
calculate set points as a function of instructions, said instructions comprising internal piloting instructions generated by the automatic pilot and external instructions received by the drone, said internal instructions and external instructions comprising turn instructions, move up/move down instructions and speed change instructions, said set points including a roll angle set point (φ), a pitch angle set point ( [symbol] ) and a speed set point (V) for the implementation of the internal and/or external instructions; and
control the propulsion system and the control surfaces as a function of the calculated set points,
upon application of a turn instruction and/or a speed change instruction, calculate said roll angle set point (φ), said pitch angle set point ( [symbol] ) and said speed set point (V) so as to perform a turn and/or a speed change while maintaining constant an altitude (z) of the drone during the turn and/or the speed change, and
upon cessation of receipt of at least certain of said external piloting instructions generate said roll angle set point (φ), said pitch angle set point ( [symbol] ) and said speed set point (V) so as to maintain constant the heading and the altitude the drone had at the time of said cessation of receipt of at least certain of said external piloting instructions.

2. The drone according to claim 1, wherein the automatic pilot is further configured to, upon cessation of receipt of any external piloting instruction, generate said roll angle set point (φ), said pitch angle set point ( [symbol] ) and said speed set point (V) so as to further maintain constant the speed the drone had at the time of said cessation of receipt of any external piloting instruction.

3. The drone according to claim 1, wherein said at least certain external piloting instructions comprise the turn external piloting instructions and the move up/move down external piloting instructions, and do not comprise the speed external piloting instructions.

4. The drone according to claim 3, wherein the automatic pilot is further con-figured to, upon receipt of speed external piloting instructions and with no receipt of turn external piloting instructions nor receipt of move up/move down external piloting instructions:
continue generating said roll angle set point (φ) and said pitch angle set point ( [symbol] ) so as to maintain constant the heading and the altitude the drone had at the time of said cessation of receipt of turn external piloting instructions and move up/move down external piloting instructions, and
generate said speed set point (V) based on the move up/move down external piloting instructions received.

5. The drone according to claim 3, wherein the automatic pilot is further configured to, upon receipt of turn external piloting instructions or move up/move down external piloting instructions:
stop generating said roll angle set point (φ), said pitch angle set point ( [symbol] ) and said speed set point (V) that had been generated so as to maintain constant the heading and the altitude the drone had at the time of said cessation of receipt of turn external piloting instructions and move up/move down external piloting instructions.

6. The drone according to claim 1, wherein, in an autonomous operating mode, the automatic pilot is configured to generate internal piloting instructions including turn instructions, move up/move down instructions and/or speed instructions.

7. The drone according to claim 1, wherein the automatic pilot is configured to generate internal piloting instructions according to an automatic take-off mode with a phase of moving up to a predetermined altitude followed with a phase of waiting in orbital flight at the predetermined altitude.

8. The drone according to claim 7, wherein the automatic take-off mode comprises successively:
a phase of operating the propulsion unit of the propulsion system at slow speed,
a phase of operating the propulsion unit at a faster speed,
a phase of moving up in straight line with holding of the heading, and said phase of waiting in orbital flight when said predetermined altitude is reached.

9. The drone according to claim 1, wherein the automatic pilot is configured to generate internal piloting instructions according to an automatic landing mode, with potential superimposition, onto the piloting instructions generated by the automatic pilot, of external piloting instructions received by the drone.

10. The drone according to claim 9, wherein this automatic landing mode comprises successively:
a phase of moving down to a predetermined altitude,
a phase of moving down along a helical trajectory or according to a linear trajectory, and
a phase of inversion of the direction of rotation of the propulsion unit of the propulsion system.

11. The drone according to claim 1, wherein the automatic pilot is configured to calculate the set points as a function of a difference between the air speed of the drone and the ground speed of the drone.

12. The drone according to claim 1, wherein the automatic pilot is configured to calculate the set points so as to fly at constant air speed or at constant ground speed in a constant-speed operating mode.

13. The drone according to claim 1, wherein, for the execution of a turn instruction, the automatic pilot is configured to calculate the set points so as to perform the turn with a constant turn rate with respect to the ground.

14. A method of piloting a fixed-wing drone comprising a propulsion system, control surfaces and an automatic pilot, the method comprising the steps of:
calculating set points as a function of piloting instructions comprising internal instructions, generated by the automatic pilot, and/or external instructions, received by the drone, said internal instructions and external instructions comprising turn instructions, move up/move down instructions and speed change instructions, said set points including a roll angle set point (φ), a pitch angle set point ( [symbol] ) and a speed set point (V) for the implementation of the internal and/or external instructions;
upon application of a turn instruction and/or a speed change instruction, calculating said roll angle set point (φ), said pitch angle set point ( [symbol] ) and said speed set point (V) so as to perform a turn and/or a speed change while maintaining constant an altitude (z) of the drone during the turn and/or the speed change;
controlling the propulsion system and the control surfaces as a function of the calculated set points; and
upon cessation of receipt of at least certain of said external piloting instructions, generating said roll angle set point (φ), said pitch angle set point ( [symbol] ) and said speed set point (V) so as to maintain constant the heading and the altitude the drone had at the time of said cessation of receipt of at least certain of said external piloting instructions.

15. The method according to claim 14, wherein, upon cessation of receipt of any external piloting instruction, said roll angle set point (φ), said pitch angle set point ( [symbol] ) and said speed set point (V) are generated so as to further maintain constant the speed the drone had at the time of said cessation of receipt of any external piloting instruction.

16. The method according to claim 14, wherein said at least certain external piloting instructions comprise the turn external piloting instructions and the move up/move down external piloting instructions, and do not comprise the speed external piloting instructions.

17. The method according to claim 16, further comprising, upon receipt of speed external piloting instructions and with no receipt of turn external piloting instructions nor receipt of move up/move down external piloting instructions, continuing generating said roll angle set point (φ) and said pitch angle set point (□) so as to maintain constant the heading and the altitude the drone had at the time of said cessation of receipt of turn external piloting instructions and move up/move down external piloting instructions, and generating said speed set point (V) based on the move up/move down external piloting instructions received.

18. The method according to claim 16, further comprising, upon receipt of turn external piloting instructions or move up/move down external piloting instructions, stopping generating said roll angle set point (φ), said pitch angle set point ( [symbol] ) and said speed set point (V) that had been generated so as to maintain constant the heading and the altitude the drone had at the time of said cessation of receipt of turn external piloting instructions and move up/move down external piloting instructions
